(19) United States
(12) Patent Application Publication
(10) Pub. No.: US 2016/0107110 A1
(43) Pub. Date: Apr. 21, 2016

(54) FILTER ASSEMBLY FOR FLUID SUPPLY SYSTEM

(71) Applicant: Caterpillar Inc., Peoria, IL (US)

(72) Inventors: Mark T. Allott, Mapleton, IL (US); Bryant A. Morris, Peoria, IL (US); Jeffrey R. Ries, Metamora, IL (US)

(73) Assignee: Caterpillar Inc., Peoria, IL (US)

(21) Appl. No.: 14/979,707

(22) Filed: Dec. 28, 2015

(51) Int. Cl. B01D 35/147; B01D 35/00

(52) U.S. Cl. CPC B01D 35/147; B01D 35/005

(57) ABSTRACT

A filter assembly includes housing and a filter device disposed within the housing to define a circumferential cavity therebetween. The filter assembly further includes a bypass valve having a housing wall, multiple inlets and an outlet formed on the housing wall, and a valve member. A first end of the valve member is coupled to a valve seat and a second end of the valve member engages with the outlet of the bypass valve. The valve member is displaced from a first position to a second position when pressure of fluid in the circumferential cavity is greater than a biasing force of a spring, and wherein the valve member engages with the outlet port of the bypass valve against the biasing force of the spring in the first position and the valve member allows the fluid to flow into the hollow center tube in the second position.

### TECHNICAL FIELD

The present disclosure relates to a filter assembly for a fluid supply system and more particularly to the filter assembly equipped with bypass functionality.

### BACKGROUND

Generally, a fluid supply system of an engine is equipped with a filter assembly that includes multiple filters, to eliminate contaminants from fluids flowing through the fluid supply system. The filters are typically used in connection with lubrication systems and fuel supply systems for internal combustion systems and hydraulic systems. Further, the filters are equipped with replaceable filter media. As such, the filter media in the filters can be replaced, rather than replacing the entire filter. Contaminated fluid flowing into the filter passes through the filter media to get filtered, and the filtered fluid is thereafter supplied to the internal combustion systems and hydraulic systems. Due to deposition of contaminants in the filter, a pressure build-up may be developed between a flow path of the contaminated fluid and a flow path of the filtered fluid. In such cases, upon excess pressure build-up, the flow of filtered fluid through the internal combustion systems and the hydraulic systems can become limited, which can hinder the operation and potentially damage downstream systems. In order to overcome the pressure build-up, the filters are incorporated with a fluid bypass that opens upon the excess pressure build-up. The fluid bypass allows the contaminated fluid to enter the flow path of the filtered fluid, to prevent any failure of the downstream systems.

U.S. Pat. No. 8,083,938, hereinafter referred to as the '938 patent, discloses a filter assembly and a filter element. The filter assembly includes a filter base in which a filter element is mounted. The filter element includes a bypass valve carried by the filter element that operates independent of and free of interaction with the filter base. The '938 patent also discloses methods that include providing an entirely new bypass valve for the filter assembly by inserting a filter element including a complete bypass valve into the filter base such that bypass valve structures of the filter base are rendered useless. However, the position of the bypass valve of the '938 patent increases time for its replacement and the maintenance cost as well. In addition, the fluid filter of the '938 patent is vulnerable to malfunctioning due to less efficient sealing arrangement provided in the fluid filter.

### SUMMARY OF THE DISCLOSURE

According to an aspect of the present disclosure, a filter assembly for a fuel supply system is provided. The filter assembly includes a housing having an inner surface, an outer surface, and a base portion. The housing also includes a port. The filter assembly further includes an end cap detachably coupled to the housing. The filter assembly further includes a filter device having an inner surface and an outer surface. The filter device is disposed coaxially within the housing to define a circumferential cavity between the outer surface of the filter device and the inner surface of the housing. The circumferential cavity being in fluid communication with the port of the housing to receive fluid into the circumferential cavity from the fluid supply system. The filter assembly further includes a hollow center tube disposed within the filter device. The hollow center tube has a first end and a second end, the first end being fastened to the base portion of the housing and the second end includes a constriction. The hollow center tube further includes a plurality of fins provided on an outer surface of the hollow center tube, each of the plurality of fins extend outward in a radial direction towards the filter device. The hollow center tube further includes a spring member having a first end and a second end. The spring member is disposed within the hollow center tube, where the first end of the spring member rests against the base portion of the housing and the second end of the spring member is disposed proximal to the second end of the of the hollow center tube. The hollow center tube further includes a valve seat disposed within the hollow center tube, and between the second end of the spring member and the constriction at the second end of the hollow center tube, where the valve seat abuts the constriction against a biasing force of the spring member. The filter assembly further includes a bypass valve having a first end and a second end, the first end coupled to the end cap and the second end being disposed within the filter device. The bypass valve includes a housing wall defining a chamber therein. The housing wall includes one or more inlet ports to allow fluid communication between the circumferential cavity and the chamber, and an outlet port to allow fluid communication between the chamber and the hollow center tube. The bypass valve further includes a valve member having a first end and a second end, where the first end of the valve member is coupled to the valve seat and the second end of the valve member engages with the outlet of the bypass valve. The valve member is displaced from a first position to a second position when a pressure of the fluid in the circumferential cavity is greater than the biasing force of the spring, and wherein the valve member engages with the outlet port of the bypass valve against the biasing force of the spring in the first position and the valve member allows the fluid to flow into the hollow center tube in the second position.

Other features and aspects of this disclosure will be apparent from the following description and the accompanying drawings.

### BRIEF DESCRIPTION OF THE DRAWINGS

FIG. 1 is a block diagram of a fluid supply system, according to one embodiment of the present disclosure;

FIG. 2 is a cross-sectional view of a filter assembly of the fluid supply system;

FIG. 3 is a bottom perspective view of an end cap of the filter assembly of FIG. 2;

FIG. 4 is a cross-sectional view of a filter device of the filter assembly of FIG. 2; and

FIG. 5 is a top perspective view of a portion of the cross-section of the filter assembly of FIG. 2.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

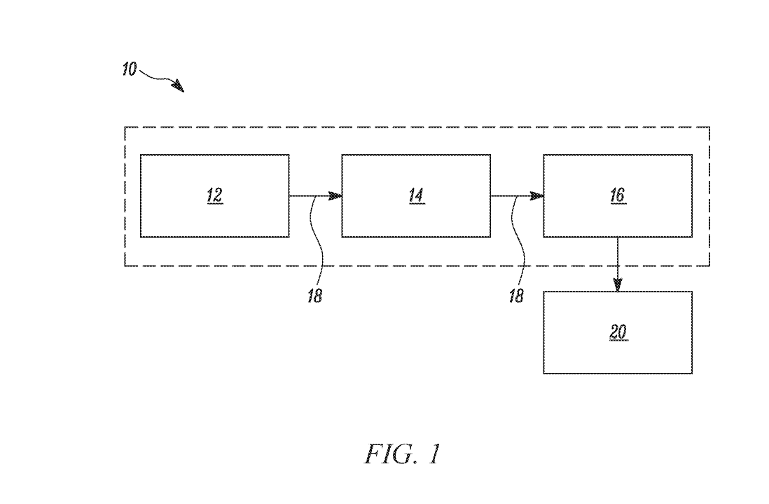

FIG. 1 illustrates a schematic block diagram of a fluid supply system 10. The fluid supply system 10 includes a fluid tank 12, a fluid pump 14, and a filter assembly 16 connected via fluid flow lines 18. The fluid pump 14 may supply fluid, such as lubrication oil, from the fluid tank 12 to the filter assembly 16. The filter assembly 16 may be one of several components within the fluid supply system 10 and is adapted to receive the fluid either from the fluid pump 14 or from one or more upstream components of the fluid supply system 10. In an example, the filter assembly 16 may be a lube filter, a fuel filter, a hydraulic fluid filter, a coolant filter, or any other filter that facilitates filtering of the fluid. Particles suspended within the fluid are filtered and subsequently supplied to downstream systems 20. In an example, the downstream systems 20 may include, but is not limited to, engine, auxiliary gearbox, and transmission system. Further the filter assembly 16 may be oriented in a top-load configuration. The top-load configuration allows servicing or access to the filter assembly 16 from a position above the filter assembly 16.

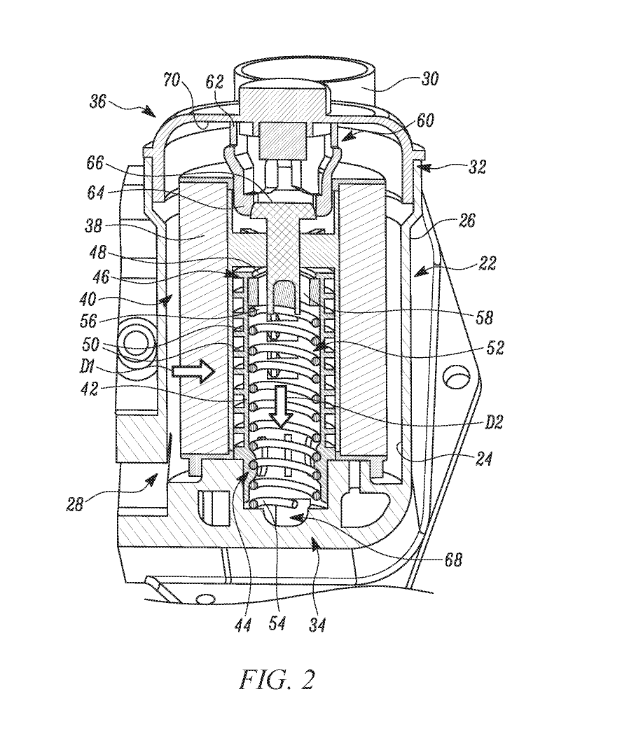

FIG. 2 illustrates a cross-sectional view of the filter assembly 16. The filter assembly 16 includes a housing 22 having an inner surface 24 and an outer surface 26. The inner surface 24 and the outer surface 26 define a thickness of the housing 22. The housing 22 shown in FIG. 2 has a circular cross-section. However, in an example, cross-section of the housing 22 may be a square, a rectangle, a polygon, or an ellipse. The housing 22 may be mounted or coupled at a location in the fluid supply system 10 to perform the function of filtering fluid. The housing 22 further includes a port 28 for receiving the fluid into the housing 22. Alternatively, the fluid can also be supplied into the housing 22 via an auxiliary port 30 provided in the housing 22. The housing 22 also includes a head portion 32 and a base portion 34.

The filter assembly 16 further includes an end cap 36 coupled to the housing 22. Specifically, the end cap 36 is coupled to the head portion 32 of the housing 22 in a manner, such that the end cap 36 can be detached from the housing 22 when required. The end cap 36 shown in FIG. 2 has a semicircular cross-section. However, it will be understood that the end cap 36 may be provided with various other cross-sections, such that the end cap 36 can be coupled to the head portion 32 of the housing 22. In addition, the end cap 36 also provides access to components housed in the housing 22, when the end cap 36 is detached from the housing 22. In one example, the end cap 36 may be threadably coupled to the housing 22. In another example, a snap fit arrangement may be provided between the end cap 36 and the housing 22 to facilitate easy coupling and detachment of the end cap 36 to and from the housing 22, respectively.

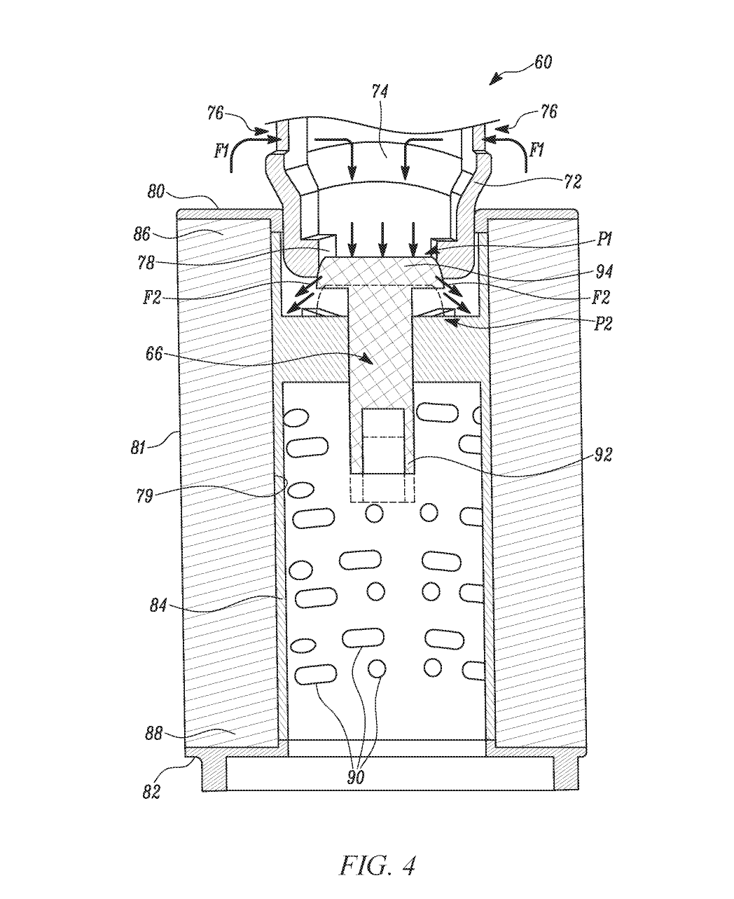

The filter assembly 16 further includes a filter device 38 disposed coaxially within the housing 22. The filter device 38 shown in FIG. 2 has a circular cross-section. However, it will be understood that the cross-section of the filter device 38 may be one of a square, a rectangle, a polygon, or an ellipse. The cross-section of the filter device 38 may be defined according to the cross-section of the housing 22. In such an arrangement, the filter device 38 defines a circumferential cavity 40 between an outer surface 81 (shown in FIG. 4) of the filter device 38 and the inner surface 24 of the housing 22. The circumferential cavity 40 is in fluid communication with the port 28 of the housing 22 to receive fluid into the circumferential cavity 40 from the fluid supply system 10.

The filter assembly 16 further includes a hollow center tube 42 disposed within the filter device 38. In one example, the hollow center tube 42 may be coaxially disposed within the filter device 38. The hollow center tube 42 has a first end 44 and a second end 46. The first end 44 of the hollow center tube 42 is attached to the base portion 34 of the housing 22 and the second end 46 of the hollow center tube 42 is disposed distal from the base portion 34. The first end 44 of the hollow center tube 42 can be fastened to the base portion 34 of the housing 22 as shown in FIG. 2. Further, the second end 46 of the hollow center tube 42 includes a constriction 48. In an example, the constriction 48 may be provided as a protrusion that radially extends inward and away from the filter device 38, as shown in FIG. 2.

The hollow center tube 42 further includes multiple fins 50 provided on an outer surface (not shown) of the hollow center tube 42. Each of the multiple fins 50 form an integral part of the hollow center tube 42 and extend outward in a radial direction towards the filter device 38. In one example, the fins 50 may be provided as individual protrusions that extend radially from the outer surface of the hollow center tube 42. In another example, a helical protrusion may be provided on the outer surface of the hollow center tube 42 to function similar to that of fins 50. Further, the hollow center tube 42 may be casted from variety of materials including plastic, metal, or any other materials known in the art.

The hollow center tube 42 further includes an elastic member 52, such as a spring, disposed within the hollow center tube 42. In one example, the elastic member 52 may be disposed coaxially within the hollow center tube 42. The elastic member 52 has a first end 54 and a second end 56. The first end 54 of the elastic member 52 rests against the base portion 34 of the housing 22 and the second end 56 of the elastic member 52 disposed proximal to the second end 46 of the hollow center tube 42, when the hollow center tube 42 is coupled to the housing 22. Specifically, the first end 54 of the elastic member 52 abuts the base portion 34 of the housing 22 and the second end 56 of the elastic member 52 rests against the constriction 48 of the hollow center tube 42. Although the description herein is with respect to the spring, it will be understood that other forms of the elastic member 52, such as an elastic disc or a diaphragm, may be employed instead of the spring. In such cases, periphery of the elastic disc or the diaphragm may be attached to an inner surface of the hollow center tube 42.

The hollow center tube 42 also includes a valve seat 58 disposed within the hollow center tube 42. In addition, the valve seat 58 is disposed between the second end 56 of the elastic member 52 and the constriction 48. In such a condition, the valve seat 58 rests on the constriction 48 against a biasing force of the elastic member 52.

In order to control a pressure build-up condition, the filter assembly 16 further includes a bypass valve 60 disposed in the housing 22. The bypass valve 60 has a first end 62 and a second end 64. The first end 62 of the bypass valve 60 is coupled to an inner surface 70 of the end cap 36 and the second end 64 of the bypass valve 60 is disposed within the filter device 38, as shown in FIG. 2. A valve member 66 of the bypass valve 60 is disposed within the filter device 38 to engage with the second end 64 of the bypass valve 60. The manner in which the bypass valve 60 aids in minimizing the pressure build-up in the filter assembly 16 will be described later in the description.

In operation, during normal condition of filtering of fluid in the filter assembly 16, the fluid received into the circumferential cavity 40 travels in an inward direction D1 radially into the filter device 38 to get filtered. The filtered fluid enters the hollow center tube 42, travels in a downward direction D2, exits through a supply port 68, and is supplied to the downstream systems 20 thereafter.

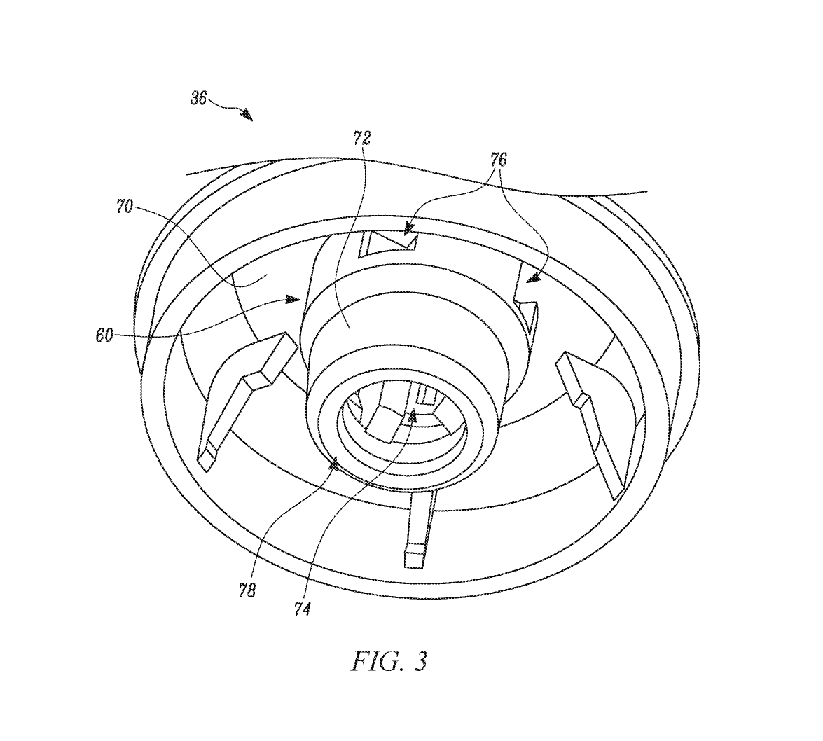

FIG. 3 illustrates a bottom perspective view of the end cap 36 of the filter assembly 16 and the bypass valve 60 attached to the end cap 36 thereof. For the purpose of illustration, the bypass valve 60 is illustrated without the valve member 66 in FIG. 3. In one example, the first end 62 of the bypass valve 60 may be detachably engaged with the inner surface 70 so that the bypass valve 60 may be replaced when required. For instance, the first end 62 of the bypass valve 60 may be threadably coupled to the inner surface 70 of the end cap 36. In another example, the bypass valve 60 and the end cap 36 may be provided as a single component.

The bypass valve 60 includes a housing wall 72 that defines a chamber 74 therein. In one example, the housing wall 72 may be made from thermoplastic, polyurethane, or acrylic. The housing wall 72 includes one or more inlet ports 76 formed proximal to the inner surface 70 of the end cap 36 and an outlet port 78 formed distal from the inner surface 70 of the end cap 36. In one example, the housing wall 72 may have a tapering cross-section. In other words, a width of the housing wall 72 decreases from the first end 62 of the bypass valve 60 to the second end 64 of the bypass valve 60. Additionally, the width of the bypass valve 60 at the second end 64 is so formed, such that the second end 64 is capable of being inserted into the hollow center tube 42. Further, the inlet ports 76 are in fluid communication with the circumferential cavity 40, thereby allowing fluid communication between the circumferential cavity 40 and the chamber 74. That is, the fluid from the circumferential cavity 40 is allowed to flow in a first flow path “F1” (shown in FIG. 4) and occupy the space in the chamber 74. Likewise, the outlet port 78 of the housing wall 72 allows fluid communication between the chamber 74 and the hollow center tube 42.

FIG. 4 illustrates a cross-sectional view of the filter device 38 of the filter assembly 16. The filter device 38 includes an inner surface 79 and an outer surface 81. The inner surface 79 may be understood as an inner peripheral surface proximal with respect to the valve member 66 and the outer surface 81 may be understood as an outer peripheral surface distal with respect to the valve member 66. The filter device 38 is surrounded by a first seal member 80, a second seal member 82, and an inner lining member 84. The first seal member 80 is secured to a first end 86 of the filter device 38 and the second seal member 82 is secured to a second end 88 of the filter device 38. In addition, the first seal member 80 contacts an outer surface of the housing wall 72 of the bypass valve 60, thereby providing a seal therebetween to restrict entry of fluid into the hollow center tube 42. The inner lining member 84 is secured to the inner surface 79 of the filter device 38. With such an arrangement, the first seal member 80, the second seal member 82, and the inner lining member 84 provides strength and packaging to the filter device 38. As such, the filter device 38 may be obtained as a single component along with the first seal member 80, the second seal member 82, and the inner lining member 84 attached at the respective locations on the filter device 38. In order to allow the filtered fluid to enter the hollow center tube 42, the inner lining member 84 includes multiple apertures 90. As such, the fluid entering the filter device 38 from the circumferential cavity 40 in the inward direction D1 gets filtered and thereafter passes through the apertures 90 to enter the hollow center tube 42. Subsequently, the filtered fluid flows in the downward direction D2 and is supplied to the downstream systems 20.

FIG. 4 also shows the valve member 66 of the bypass valve 60. The valve member 66 has a first end 92 and a second end 94. The first end 92 of the valve member 66 is coupled to the valve seat 58 and the second end 94 of the valve member 66 is engaged with the outlet port 78 of the bypass valve 60. In particular, the second end 94 of the valve member 66 abuts a periphery of the outlet port 78 of the housing wall 72, thereby restricting flow of the fluid through the outlet port 78 in the normal condition of filtering of the fluid.

In case, when a pressure difference exists between the fluid contained in the circumferential cavity 40 and the hollow center tube 42, the filtering of the fluid is either minimized or ceased. In such a case, the fluid from the circumferential cavity 40 enters in the first flow path “F1” and applies a pressure on the second end 94 of the valve member 66 as shown in FIG. 4. As described in FIG. 3, the valve seat 58 is disposed in the hollow center tube 42 against the biasing force of the elastic member 52. Accordingly, when the pressure of the fluid in the circumferential cavity 40, or the pressure of fluid being applied on the valve member 66, is greater than the biasing force of the elastic member 52, the valve member 66 is displaced from a first position “P1” to a second position “P2”. The valve member 66 is engaged with the periphery of the outlet port 78 against the biasing force of the elastic member 52 in the first position “P1” and the valve member 66 allows the fluid to flow into the hollow center tube 42 in the second position “P2”. Accordingly, the fluid, flows into the hollow center tube 42 from the chamber 74 in a second flow path “F2”, as shown in FIG. 4.

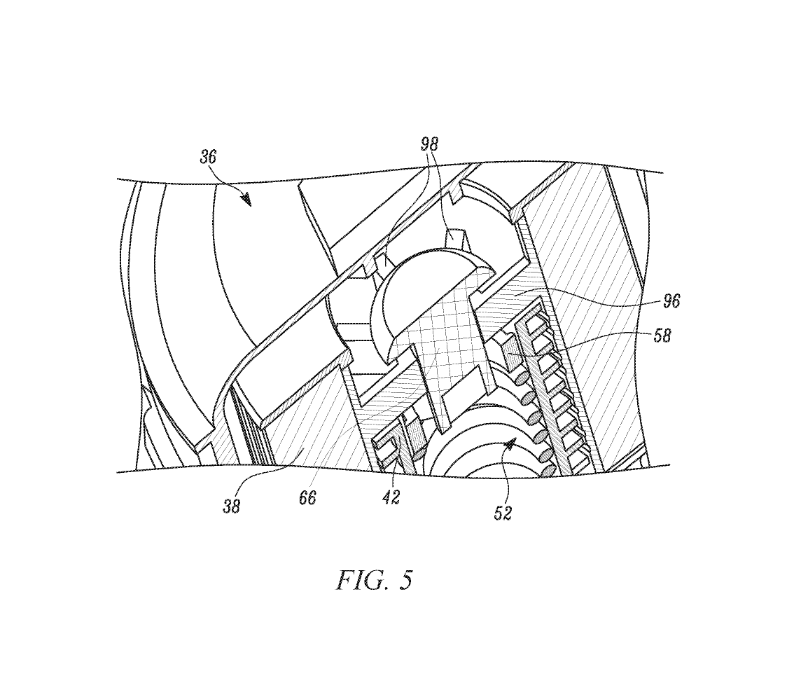

FIG. 5 illustrates a top perspective view of a portion of the cross-section of the filter assembly 16. The inner lining member 84 also includes a support member 96 to support the valve member 66 in addition to the support provided by the valve seat 58. In one example, the support member 96 may be an integral part of the inner lining member 84. One or more arms 98 are provided in the support member 96 to add structural stability to the support member 96. The arms 98 also restrict movement of the valve member 66 at a predetermined limit during the displacement of the valve member 66 from the first position “P1” to the second position “P2”. Further, the fluid flowing out of the chamber 74 of the bypass valve 60 in the second flow path F2 flows through spaces between the arms 98, and subsequently enters the hollow center tube 42, as shown in the FIG. 5.

In an alternate embodiment, a pressure sensor (not shown) may be disposed in the circumferential cavity 40 to measure pressure of the fluid received in the circumferential cavity 40. Further, the pressure sensor may be disposed in communication with a controller (not shown). The pressure sensor may be configured to generate a signal when the pressure of the fluid in the circumferential cavity 40 is above a threshold pressure. The controller may be configured to receive the signal from the pressure sensor and provide an indication to an operator regarding the pressure difference condition. Accordingly, the operator may also be provided with an indication to initiate maintenance process of the filter assembly 16.

### INDUSTRIAL APPLICABILITY

The present disclosure relates to the filter assembly 16. Owing to the presence of the first seal member 80, the second seal member 82, and the inner lining member 84 secured to the respective surfaces of the filter device 38 of the filter assembly 16, the filter device 38 can be structured as a single component. In such a condition, the filter device 38 may be disengaged easily from the filter assembly 16 and may be replaced without additional efforts during the replacement of the filter device 38 or during servicing of the filter assembly 16. Therefore, the filter assembly 16 of the present disclosure has a simple design and components of the filter assembly 16 can be obtained at less cost, thereby minimizing the cost of the filter assembly 16, unlike the conventional filter assemblies.

Further, during the pressure build-up condition, that is when the pressure difference exists between the circumferential cavity 40 and the hollow center tube 42, the bypass valve 60 provides to efficiently minimize the pressure difference, thereby preventing failure of the filter assembly 16 and the downstream systems 20. In other words, the bypass valve 60 bypasses the fluid from the circumferential cavity 40 to the hollow center tube 42 during the pressure build-up condition, thereby eliminating any further pressure build-up in the filter assembly 16.

Furthermore, when the pressure difference between the circumferential cavity 40 and the hollow center tube 42 is reduced, the pressure applied by the fluid on the valve member 66 also decreases. Such reduced pressure condition allows the valve member 66 to be pushed against the biasing force of the elastic member 52 and rest against the periphery of the outlet port 78 in the bypass valve 60, thereby restricting any further flow of fluid from the bypass valve 60 to the hollow center tube 42. With such an arrangement, the filter assembly 16 of the present disclosure efficiently controls the flow of fluid and the filtering of the fluid through the filter assembly 16.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments can be understood to fall within the scope of the present disclosure as determined based upon the claims and any equivalents thereof.

What is claimed is:

1. A filter assembly for a fluid supply system, the filter assembly comprising:
a housing having an inner surface, an outer surface, and a base portion, the housing comprises a port;
an end cap detachably coupled to the housing;
a filter device having an inner surface and an outer surface, the filter device disposed coaxially within the housing to define a circumferential cavity between the outer surface of the filter device and the inner surface of the housing, the circumferential cavity being in fluid communication with the port of the housing to receive fluid into the circumferential cavity from the fluid supply system;
a hollow center tube disposed within the filter device, the hollow center tube has a first end and a second end, the first end being fastened to the base portion of the housing and the second end includes a constriction, and wherein the hollow center tube includes:
an elastic member having a first end and a second end, the elastic member being disposed within the hollow center tube, wherein the first end of the elastic member rests against the base portion of the housing and the second end of the elastic member is disposed proximal to the second end of the of the hollow center tube; and
a valve seat disposed within the hollow center tube, and between the second end of the elastic member and the constriction at the second end of the hollow center tube, wherein the valve seat abuts the constriction against a biasing force of the elastic member;
a bypass valve having a first end and a second end, the first end coupled to the end cap and the second end being disposed within the filter device, the bypass valve includes:
a housing wall defining a chamber therein, the housing wall includes one or more inlet ports to allow fluid communication between the circumferential cavity and the chamber, and an outlet port to allow fluid communication between the chamber and the hollow center tube; and
a valve member having a first end and a second end, wherein the first end of the valve member is coupled to the valve seat and the second end of the valve member engages with the outlet of the bypass valve;
wherein the valve member is displaced from a first position to a second position when a pressure of the fluid in the circumferential cavity is greater than the biasing force of the elastic member, and wherein the valve member engages with the outlet port of the bypass valve against the biasing force of the elastic member in the first position and the valve member allows the fluid to flow into the hollow center tube in the second position.
